(19) United States
(12) Patent Application Publication
(10) Pub. No.: US 2026/0260917 A1
(43) Pub. Date: Sep. 3, 2026

(54) Fuel Cell System And Method Of Returning From Idle Stop Operation To Normal Operation

(71) Applicant: HONDA MOTOR CO., LTD., MINATO-KU (JP)

(72) Inventor: Shuto MANIWA, WAKO-SHI (JP)

(21) Appl. No.: 19/551,082

(22) Filed: Feb. 26, 2026

(30) Foreign Application Priority Data
Mar. 3, 2025 (JP) 2025-033002

(51) Int. Cl. H01M 8/04992; H01M 8/04082; H01M 8/04111; H01M 8/04303; H01M 8/0432; H01M 8/04537; H01M 8/04746; H01M 8/04858; H01M 16/00; B60L 50/72; H01M 8/10

(52) U.S. Cl. CPC H01M 8/04992; H01M 8/04111; H01M 8/04201; H01M 8/04303; H01M 8/04335; H01M 8/04589; H01M 8/04626; H01M 8/04753; H01M 8/0494; H01M 16/006; B60L 50/72; H01M 2008/1095; H01M 2220/20; H01M 2250/20; H01M 2250/402

(57) ABSTRACT

A control device includes an idle stop determination unit that determines a transition from a normal operation in which a fuel cell generates electric power to an idle stop operation in which electric power generation of the fuel cell is temporarily stopped and determines a return from the idle stop operation to the normal operation, and a return processing unit that when the idle stop determination unit determines the return to the normal operation, causes a fuel gas supply device to start supplying a fuel gas to the fuel cell and causes an oxygen-containing gas supply device to supply an oxygen-containing gas.

### CROSS-REFERENCE TO RELATED APPLICATIONS

This application is based upon and claims the benefit of priority from Japanese Patent Application No. 2025-033002 filed on March 3, 2025, the contents of which are incorporated herein by reference.

### BACKGROUND OF THE INVENTION

### Field of the Invention

The present disclosure relates to a fuel cell system including a fuel cell that generates electricity by a chemical reaction between a fuel gas and an oxygen-containing gas, and a method of returning from an idle stop operation to a normal operation in the fuel cell system.

### Description of the Related Art

In recent years, research and development have been conducted on fuel cells (FCs) that contribute to improvement in energy efficiency in order to ensure that more people have access to affordable, reliable, sustainable, and modern energy.

For example, JP 2008-047390 A discloses a technique for a transition control from a normal operation to an idle stop operation and a technique for return control from the idle stop operation to the normal operation in a fuel cell system.

### SUMMARY OF THE INVENTION

In the technique disclosed in JP 2008-047390 A, when the operation is transitioned from the normal operation to the idle stop operation, the operation of a compressor for supplying an oxygen-containing gas to the fuel cell is stopped (paragraphs [0026] and [0027] of JP 2008-047390 A.

In the idle stop operation, the supply of the oxygen-containing gas and the fuel gas to the fuel cell is stopped (see paragraph [0033] of JP 2008-047390 A).

When the operation mode is returned from the idle stop operation to the normal operation, the fuel gas is supplied to the fuel cell (see paragraph [0035] of JP 2008-047390 A).

Next, a rotational speed command is output to the compressor to perform an idle stop return control (see paragraph [0036] of JP 2008-047390 A).

As described above, in the technique disclosed in JP 2008-047390 A, when the operation mode is returned from the idle stop operation to the normal operation, the oxygen-containing gas is supplied after the fuel gas been supplied. Therefore, there is a problem that it takes time until the output of the fuel cell reaches the required output.

According to one aspect of the present disclosure, a fuel cell system includes a fuel cell configured to generate electric power by using a fuel gas and an oxygen-containing gas, a fuel gas supply device configured to supply the fuel gas to the fuel cell through a fuel gas supply flow path, an oxygen-containing gas supply device configured to supply the oxygen-containing gas to the fuel cell through an oxygen-containing gas supply flow path, and a control device configured to control the fuel cell, the fuel gas supply device, and the oxygen-containing gas supply device, wherein the control device includes an idle stop determination unit configured to determine the transition from the normal operation in which the fuel cell generates the electric power to the idle stop operation in which the fuel cell temporarily stops electric power generation and to determine the return from the idle stop operation to the normal operation, and a return processing unit configured to, in a case that the return to the normal operation is determined by the idle stop determination unit, start supplying the fuel gas from the fuel gas supply device to the fuel cell and supply the oxygen-containing gas from the oxygen-containing gas supply device to the fuel cell.

Another aspect of the present disclosure is characterized by a method of returning from an idle stop operation to a normal operation in a fuel cell system, the fuel cell system includes a fuel cell configured to generate electric power by using a fuel gas and an oxygen-containing gas, a fuel gas supply device configured to supply the fuel gas to the fuel cell through a fuel gas supply flow path, an oxygen-containing gas supply device configured to supply the oxygen-containing gas to the fuel cell through an oxygen-containing gas supply flow path, and a control device configured to control the fuel cell, the fuel gas supply device, and the oxygen-containing gas supply device, wherein the method includes an idle stop operation determination step of determining the transition from the normal operation in which electric power generation of the fuel cell is performed to the idle stop operation in which the electric power generation of the fuel cell is temporarily stopped, and determining the return from the idle stop operation to the normal operation, and a return process step, in a case that the return to the normal operation is determined in the idle stop determination step, starting supplying the fuel gas from the fuel gas supply device to the fuel cell and supplying the oxygen-containing gas from the oxygen-containing gas supply device to the fuel cell.

In accordance with the present disclosure, when the operation is returned from the idle stop operation to the normal operation, the fuel gas and the oxygen-containing gas are simultaneously supplied to the fuel cell to start electric power generation. Thus, the time until the output of the fuel cell reaches the required output at the time of return from the idle stop operation is shortened, and as a result, the time of return from the idle stop operation to the normal operation can be shortened as compared with the time of return after the stoppage. This in turn contributes to energy efficiency.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic configuration diagram of a fuel cell vehicle incorporating a fuel cell system that performs a method of returning from an idle stop operation to a normal operation, according to an embodiment;

FIG. 2 is a schematic diagram of a turbo compressor including an air bearing mechanism;

FIG. 3 is a flowchart for providing a description of operations of the fuel cell system shown in FIG. 1;

FIG. 4 is a flowchart of a subroutine for providing a description of a transition process from the normal operation to the idle stop operation in the flowchart of FIG. 3;

FIG. 5 is a flowchart of a subroutine for providing a description of a return process from the idle stop operation to the normal operation in the flowchart of FIG. 3; and

FIG. 6 is a timing chart for providing a description of operations of the return process from the idle stop operation to the normal operation.

### DETAILED DESCRIPTION OF THE INVENTION

### Embodiment

### Configuration

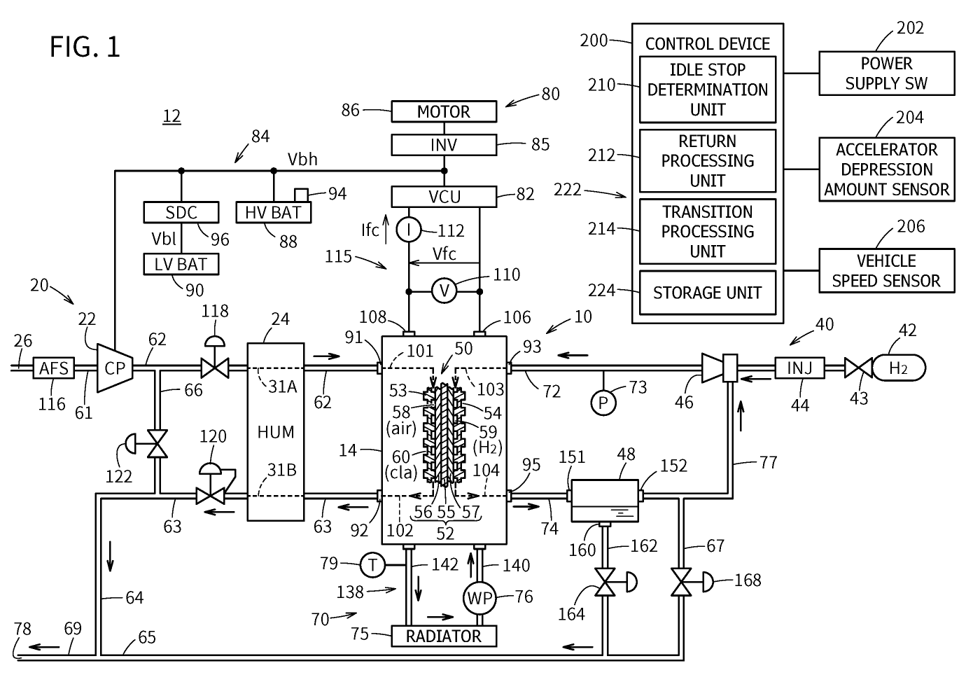

FIG. 1 is a schematic configuration diagram of a fuel cell vehicle 12 incorporating a fuel cell system 10 that performs a method of returning from an idle stop operation to a normal operation of the fuel cell system 10, according to an embodiment.

The fuel cell system 10 can be incorporated into other moving objects such as ships, aircrafts, and robots other than the fuel cell vehicle 12.

The fuel cell vehicle 12 includes the fuel cell system 10, an output unit 80 electrically connected to the fuel cell system 10, and a control device 200 for controlling the entire fuel cell vehicle 12.

The control device 200 need not necessarily be one single control device, but may be divided into two or more control devices, for example, one used for the fuel cell system 10 and one used for the output unit 80.

The fuel cell system 10 includes a fuel cell stack (also simply referred to as a fuel cell) 14, a hydrogen tank 42 as a fuel tank, an oxygen-containing gas supply device 20, a fuel gas supply device 40, and a coolant supply device 70. The oxygen-containing gas supply device 20 includes a compressor (CP) 22 and a humidifier (HUM) 24.

The fuel gas supply device 40 includes an injector (INJ) 44, an ejector 46, and a gas-liquid separator 48. The injector 44 may be replaced with a pressure reducing valve. The coolant supply device 70 includes a coolant pump (WP) 76 and a radiator 75.

The output unit 80 includes a voltage control unit (VCU) 82, an electric power storage unit 84, an inverter 85, and a motor (electric motor) 86.

The output unit 80 includes the voltage control unit 82, the inverter 85, the electric power storage unit 84, an electric power storage device (HV BAT) 88, and an electric power storage device (LV BAT) 90.

The voltage control unit 82 includes a step-up converter (SUC) and the like, and converts the power generation voltage Vfc, which is a DC voltage, into the power storage voltage Vbh, which is a higher DC voltage.

The inverter 85 converts the power storage voltage Vbh applied to the DC terminals thereof into a three-phase voltage for driving the motor 86, and outputs the three-phase voltage to the AC terminals. The power storage voltage Vbh applied to the motor 86 is a voltage obtained by boosting the power generation voltage Vfc by the voltage control unit 82 or a voltage of the electric power storage device 88. The fuel cell vehicle 12 travels by using the driving force generated by the motor 86, based on the applied power storage voltage Vbh.

The inverter 85 converts a regenerative voltage, which was generated by the motor 86 and applied to its AC terminals, into the power storage voltage Vbh and applies the voltage to the electric power storage device 88.

The electric power storage unit 84 includes, in addition to the electric power storage device 88, a low-voltage electric power storage device 90 and a step-down converter (SDC) 96 that converts a high-voltage power storage voltage Vbh into a low-voltage power storage voltage Vbl to charge the electric power storage device 90. The electric power storage device 88 is provided with an SOC (state of charge) sensor 94 that measures an SOC, which is a remaining capacity of the electric power storage device 88. The electric power storage unit 84 applies the power storage voltage Vbh of the electric power storage device 88 to the compressor 22 as a high-voltage auxiliary device.

The electric power storage unit 84 applies the power storage voltage Vbl of the electric power storage device 90 to the low-voltage auxiliary device such as the injector 44, the coolant pump 76, an air conditioner (not shown) and a solenoid valve (described later).

The loads of the voltage control unit 82 connected to the fuel cell 14 and the electric power storage unit 84 include the motor 86 (main load) as a main machine, the high-voltage auxiliary device, and the low-voltage auxiliary device (auxiliary device load).

The fuel cell stack 14 is configured by a plurality of electric power generation cells 50 that are stacked. Each of the electric power generation cells 50 includes a membrane electrode assembly (MEA) 52 and separators 53, 54 sandwiching the membrane electrode assembly 52.

The membrane electrode assembly 52 includes, for example, a solid polymer electrolyte membrane (also simply referred to as an electrolyte membrane) 55 which is a thin film of perfluorosulfonic acid containing moisture, and a cathode 56 and an anode 57 which sandwich the electrolyte membrane 55.

The cathode 56 and the anode 57 each include a gas diffusion layer (not shown) made of carbon paper or the like. An electrode catalyst layer (not shown) is formed by depositing porous carbon particles uniformly on the surface of the gas diffusion layer, and platinum alloy is supported on the surfaces of the porous carbon particles. The electrode catalyst layers are formed on both surfaces of the solid polymer electrolyte membrane 55.

On a surface of one separator 53 facing the membrane electrode assembly 52, a cathode flow field (oxygen-containing gas flow field) 58 in communication with an oxygen-containing gas inlet connection port 101 and an oxygen-containing gas outlet connection port 102 is formed.

On a surface of another separator 54 that faces the membrane electrode assembly 52, an anode flow field (a fuel gas flow field) 59 in communication with a fuel gas inlet connection port 103 and a fuel gas outlet connection port 104 is formed.

At the anode 57, by the fuel gas (hydrogen) being supplied, hydrogen ions are generated from hydrogen molecules due to an electrode reaction by the catalyst, and the hydrogen ions permeate through the electrolyte membrane 55 and move to the cathode 56, while on the other hand, electrons are released from the hydrogen molecules.

The electrons released from the hydrogen molecules move from a negative electrode terminal 106 through the voltage control unit 82, to the cathode 56 via a positive electrode terminal 108 through loads such as the motor 86.

At the cathode 56, due to the action of the catalyst, the hydrogen ions and the electrons react with the oxygen contained in the supplied oxygen-containing gas, and thereby water is generated.

A voltage sensor 110 that detects generated voltage Vfc of the fuel cell 14, is provided between electrical wires that connect the positive electrode terminal 108 and the negative electrode terminal 106 to the voltage control unit 82. The electrical wires are provided with a current sensor 112 that detects a generated current Ifc of the fuel cell 14.

The voltage sensor 110 and the current sensor 112 form a power generation state acquisition unit 115 that detects generated electric power as a power generation state. The power generation state acquisition unit 115 may be formed by only the current sensor 112.

The compressor 22 is configured by a compressor inverter (not shown) to which the high voltage power storage voltage Vbh of the electric power storage device 88 is applied, and a mechanical supercharger that is driven by a compressor motor (not shown) the rotation of which is controlled by a three-phase AC output of the compressor inverter. The compressor 22 compresses the oxygen-containing gas supplied from an oxygen-containing gas supply flow path 61 and ejects the compressed oxygen-containing gas from an oxygen-containing gas supply flow path 62.

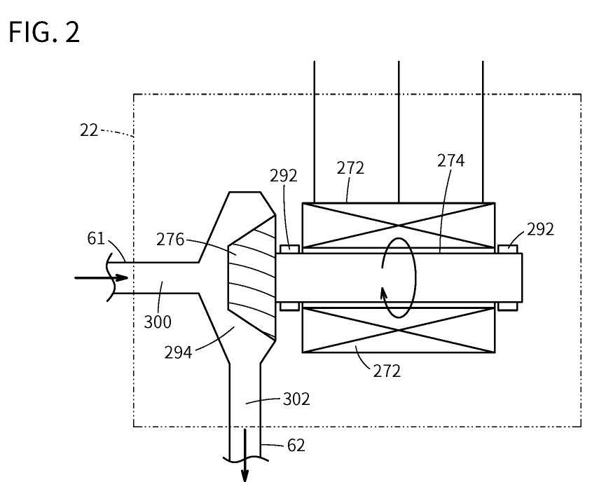

FIG. 2 is a schematic diagram of a turbo compressor 22 including an air bearing mechanism. The compressor 22 has a rotor shaft portion 274, and an impeller 276 is fixed to one end of the rotor shaft portion 274, and the impeller 276 is configured to rotate integrally with the rotor shaft portion 274. A plurality of magnets (not shown) are embedded in the cylindrical side surface of the rotor shaft portion 274 in the axial direction thereof. U-phase, V-phase, and W-phase stator coils 272 are attached to a casing (not shown) of the compressor 22. An air bearing 292 through which the rotor shaft portion 274 is inserted is attached to the casing of the compressor 22. A flow path of the oxygen-containing gas is attached to a casing of the compressor 22, and a supercharger 294 including the impeller 276 is provided in the flow path. When the impeller 276 rotates with the rotation of the rotor shaft portion 274, the air bearing 292 lifts off the rotor shaft portion 274 by the compressed air at a predetermined rotational speed or more. The predetermined rotational speed is referred to as a minimum lift-off rotational speed Nmin [rpm].

Outside air (atmosphere, air) is taken into the supercharger 294 through an intake port 300 of the compressor 22 communicating with the oxygen-containing gas supply flow path 61, and is supercharged (pressurized and compressed) by the supercharger 294. The supercharged air (oxygen-containing gas) is ejected from an ejection port 302 to the oxygen-containing gas supply flow path 62.

Referring back to FIG. 1, the compressor 22 draws in outside air from an outside air intake port 26, pressurizes the outside air as the oxygen-containing gas, and supplies the pressurized oxygen-containing gas to the fuel cell stack 14 through the humidifier 24 and the oxygen-containing gas supply flow path 62.

The humidifier 24 has a flow path 31A and a flow path 31B. Air (oxygen-containing gas) that is compressed by the compressor 22, heated to a high temperature, and dried, flows through the flow path 31A. The oxygen-containing off-gas (exhaust gas), which is a gas that is discharged from the oxygen-containing gas outlet connection port 102 of the fuel cell stack 14 via an oxygen-containing off-gas outlet 92, flows through the flow path 31B.

The humidifier 24 has a function of humidifying the oxygen-containing gas supplied from the compressor 22. That is, the humidifier 24 makes moisture contained in the oxygen-containing off-gas move from the flow path 31B to the supplied gas (oxygen-containing gas) flowing in the flow path 31A through an inside porous membrane to humidify the supply gas, and supplies the humidified oxygen-containing gas to the fuel cell stack 14 through the oxygen-containing gas supply flow path 62 and an oxygen-containing gas inlet 91.

An air flow sensor (AFS, a flow rate sensor) 116, the compressor 22, an inlet stop valve 118, and the humidifier 24 are provided in this order from the outside air intake port 26, in the oxygen-containing gas supply flow path 62 from the outside air intake port 26 to the oxygen-containing gas inlet 91. Moreover, it should be noted that the flow paths such as the oxygen-containing gas supply flow path 62 and the like, which are drawn with double lines, are formed by piping (the same feature applies hereinafter). The inlet stop valve 118 capable of shutting off the oxygen-containing gas supply flow path 62 opens and closes the oxygen-containing gas supply flow path 62.

An oxygen-containing off-gas discharge flow path 63 communicating with the oxygen-containing off-gas outlet 92 is provided with the humidifier 24 and an outlet stop valve 120 that also functions as a back pressure valve in this order, from the oxygen-containing off-gas outlet 92.

A bypass flow path 66 is provided between the suction port of the inlet stop valve 118 and the ejection port of the outlet stop valve 120, stated otherwise, between the oxygen-containing gas supply flow path 62 and the oxygen-containing off-gas discharge flow path 63. The bypass flow path 66 brings the oxygen-containing gas supply flow path 62 and the oxygen-containing off-gas discharge flow path 63 into communication, and bypasses the fuel cell 14. The bypass flow path 66 is provided with a bypass valve 122 as a flow adjustment valve that opens and closes the bypass flow path 66. The bypass valve 122 adjusts the flow rate of the oxygen-containing gas bypassing the fuel cell stack 14. A merging path between the bypass flow path 66 and the oxygen-containing off-gas discharge flow path 63 communicates with a discharge flow path 64.

The hydrogen tank (fuel tank) 42 constituting the fuel gas supply device 40 is a container that includes a hydrogen shut-off valve 43 and stores high purity hydrogen compressed at high pressure.

The fuel gas (hydrogen) discharged from the hydrogen tank 42 passes through the injector 44 and the ejector 46 that are provided in a fuel gas supply flow path 72, and is supplied to an inlet of the anode flow field (fuel gas flow field) 59 via a fuel gas inlet 93 and the fuel gas inlet connection port 103 of the fuel cell stack 14.

In this case, in the fuel gas supply flow path 72, a pressure sensor 73 is provided that detects (measures) a gas pressure (anode pressure) Pa of the fuel gas in the fuel gas supply flow path 72.

Part of the water generated by the power generation of the fuel cell 14 moves from the cathode flow field 58 to the anode flow field 59 by back-diffusion (permeation) through the membrane electrode assembly 52, and flows out in a fuel off-gas discharge flow path 74.

An outlet of the anode flow field 59 is in communication with an inlet 151 of a gas chamber of the gas-liquid separator 48 through the fuel gas outlet connection port 104, a fuel off-gas outlet 95, and the fuel off-gas discharge flow path 74.

The fuel off-gas, which is a hydrogen-containing gas containing the back-diffusion water, is supplied from the anode flow field 59 to the gas-liquid separator 48 through the fuel off-gas discharge flow path 74.

The gas-liquid separator 48 that temporarily stores the back-diffusion water separates the fuel off-gas into a gas component and a liquid component (liquid water).

The gas component (referred to as the fuel off-gas) of the fuel off-gas is discharged from a gas discharge port 152 of the gas-liquid separator 48, passes through a circulation flow path 77, and is supplied to a suction port of the ejector 46.

The fuel off-gas may flow from the gas discharge port 152 of the gas-liquid separator 48 to a discharge flow path 65 through a purge flow path 67.

The liquid component (liquid water) of the fuel off-gas flows from a liquid discharge port 160 of the gas-liquid separator 48 to the discharge flow path 65 through a drain flow path 162 provided with a drain valve 164.

The fuel off-gas and the liquid water flowing through the discharge flow path 65 are mixed with at least a part of the oxygen-containing gas and the oxygen-containing off-gas flowing through the discharge flow path 64 in order to dilute the hydrogen gas in the fuel off-gas and discharge the diluted hydrogen gas to the outside, and are discharged to the outside air through a discharge flow path 69 and an exhaust gas exhaust port 78.

When the bypass valve 122 is open, a part of the oxygen-containing gas ejected from the compressor 22 flows through the bypass flow path 66 to the discharge flow path 64.

A purge valve 168 is opened at the time of startup or at the time of return from the idle stop operation to the normal operation, in order to discharge nitrogen that has permeated through the membrane electrode assembly 52 from the cathode flow field 58 during a stoppage time (a period in which a power supply switch 202 is off) or the idle stop operation time of the fuel cell vehicle 12, or any other time.

The process of discharging the gas such as nitrogen remaining on the anode side to the outside (atmosphere) through the discharge flow path 65 and the discharge flow path 69 and replacing the gas with the fuel gas at the time of startup or at the time of return is referred to as an anode system residual gas replacement process.

The process of diluting and discharging the fuel gas, which has permeated through the membrane electrode assembly 52 from the anode flow field 59 and is present in the cathode flow field 58 during the stoppage time of the fuel cell vehicle 12 (during the period in which the power supply switch 202 is off) or during the idle stop operation time, or any other time, to the outside through the discharge flow path 64 and the discharge flow path 69 during the startup or during the return to the normal operation, is referred to as a cathode system residual hydrogen dilution process. The discharge flow path 69 discharges the liquid water and the dilution gas to the outside of the fuel cell vehicle 12 through the exhaust gas exhaust port 78.

The coolant supply device 70 of the fuel cell system 10 includes a coolant flow path 138 through which a coolant (cla) flows. The coolant flow path 138 includes a coolant supply flow path 140 and a coolant discharge flow path 142. The coolant is supplied to the fuel cell 14 through the coolant supply flow path 140, and the coolant is discharged from the fuel cell 14 through the coolant discharge flow path 142. The radiator 75 is connected to the coolant supply flow path 140 and the coolant discharge flow path 142.

The radiator 75 cools the coolant. The coolant pump 76 is provided in the coolant supply flow path 140. The coolant pump 76 circulates the coolant in a coolant circulation circuit. The coolant circulation circuit includes the coolant supply flow path 140, a coolant flow field 60 inside the fuel cell 14, the coolant discharge flow path 142, and the radiator 75. A temperature sensor 79 is provided in the coolant discharge flow path 142. Temperature (coolant outlet temperature) Ts of the coolant detected by the temperature sensor 79 is assumed as the (internal) temperature of the fuel cell 14.

The components of the fuel cell vehicle 12 equipped with the fuel cell system 10 configured as described above are integrally controlled by the control device 200. The detection values of the various sensors are acquired by the control device 200.

The inlet stop valve 118, the outlet stop valve 120, the drain valve 164, and the purge valve 168 are solenoid valves whose opening/closing or degree of opening is controlled by the control device 200. The control device 200 is a computer provided in the fuel cell system 10. The control device 200 includes a computation unit (processing unit) 222, a storage unit 224, a display unit (not illustrated), and an operation unit (not illustrated).

The computation unit 222 may be constituted by a processor such as a CPU, a GPU, or the like. That is, the computation unit 222 may be configured by a processing circuitry.

The computation unit 222 includes a return processing unit 212, a transition processing unit 214, and an idle stop determination unit 210. The return processing unit 212, the transition processing unit 214, and the idle stop determination unit 210 can be realized by programs stored in the storage unit 224 being executed by the computation unit (processor) 222.

Moreover, at least a portion of the control device 200 may be realized by an integrated circuit such as an ASIC, an FPGA, or the like. Further, at least a portion of the control device 200 may be configured by an electronic circuit including a discrete device.

The storage unit 224 may be constituted by a volatile memory and a nonvolatile memory. As the volatile memory, there may be cited, for example, a RAM. The volatile memory is used as a working memory of the processor, and temporarily stores data or the like necessary for processing or calculations. As the nonvolatile memory, there may be cited, for example, a ROM, a flash memory, or the like. The nonvolatile memory is used as a storage memory, and stores therein programs, tables, maps, and the like. At least a portion of the storage unit 224 may be provided in the processor, the integrated circuit, or the like, which were described above.

The power supply switch (power supply SW) 202 of the fuel cell vehicle 12, an accelerator depression amount sensor 204 that outputs a signal (depression amount signal) corresponding to the depression amount of an accelerator pedal (not shown), and a vehicle speed sensor 206 are connected to the control device 200.

The power supply switch 202 starts or continues (ON), and terminates (OFF) the power generation operation of the fuel cell 14 of the fuel cell system 10.

The computation unit 222 of the control device 200 performs several functions by executing calculation in accordance with the program with reference to the sensor values of the various sensors, and performs operation control of the fuel cell vehicle 12 and the fuel cell system 10.

The idle stop determination unit 210 determines a transition from a normal operation in which the fuel cell 14 generates electric power to an idle stop operation in which the electric power generation of the fuel cell 14 is temporarily stopped, and determines the return from the idle stop operation to the normal operation.

In the case that the idle stop determination unit 210 determines that the idle stop operation has been returned to the normal operation, the return processing unit 212 starts the supply of the fuel gas from the fuel gas supply device 40 to the fuel cell 14, opens the inlet stop valve 118 and the outlet stop valve 120, and supplies the oxygen-containing gas from the oxygen-containing gas supply device 20 to the fuel cell 14.

The transition processing unit 214 performs processing such as control of the compressor 22 and opening and closing of the bypass valve 122 in order to smoothly perform transition from the normal operation to the idle stop operation.

### Operation

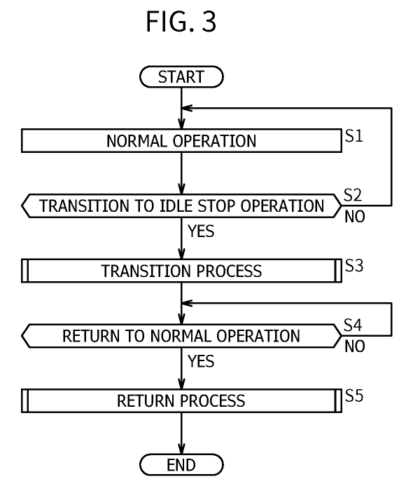

The fuel cell system 10 according to the present embodiment is configured basically as described above. Hereinafter, the operation of the fuel cell system 10 will be described with reference to the flowchart of FIG. 3.

The process according to the flowchart of FIG. 3 shows a process of the idle stop operation and the normal operation of the fuel cell vehicle 12 when the power supply switch 202 is in the ON state. In step S1, the control device 200 causes the fuel cell system 10 to perform the normal operation.

During the normal operation, the fuel cell system 10 generates electric power according to the operating state of the load (the main load and the auxiliary device load) based on the required output depending on the depression amount acquired by the accelerator depression amount sensor 204.

In step S2 during the normal operation, the idle stop determination unit 210 of the control device 200 determines whether or not a transition condition to the idle stop operation has occurred.

The idle stop determination unit 210 determines Yes in the case that, for example, the fuel cell vehicle 12 is stopped to wait for a traffic light (step S2: YES).

Alternatively, the idle stop determination unit 210 determines Yes under a certain condition, including the case that the electric power required by the main load such as the motor 86 and the auxiliary device load such as the compressor 22 can be covered by the supply of electric power from only the electric power storage device 88 having a high SOC during traveling of the fuel cell vehicle 12 (step S2: YES). When the determination is Yes, the control device 200 advances the process to step S3.

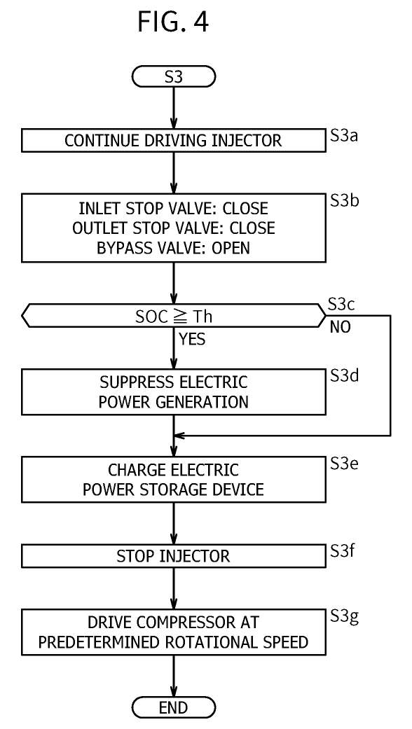

In step S3, the transition processing unit 214 of the control device 200 performs transition process from the normal operation to the idle stop operation. FIG. 4 shows a subroutine of the transition process.

In step S3a, the control device 200 continues driving the injector 44 without immediately stopping the injector 44, and advances the process to step S3b.

In step S3b, the control device 200 closes the inlet stop valve 118 and the outlet stop valve 120, opens the bypass valve 122, and advances the process to step S3c.

In step S3c, the control device 200 determines whether or not the SOC detected by the SOC sensor 94 is equal to or higher than a threshold value Th.

In the case that the SOC is equal to or higher than the threshold value Th (step S3c: YES), the process proceeds to step S3d, and in the case that the SOC is less than the threshold value Th (step S3c: NO), the process is advanced to step S3e.

In step S3d, the control device 200 controls the voltage control unit 82 to reduce the generated current Ifc of the fuel cell 14 and suppresses electric power generation (to avoid excessive electric power generation), and in this state, the control device 200 charges the electric power storage device 88 with the generated electric power in step S3e, and advances the process to step S3f. In step S3d, the generated current Ifc is suppressed so that the SOC detected by the SOC sensor 94 does not exceed the threshold value Th.

In the case that the SOC is less than the threshold value Th (step S3c: NO), the control device 200 charges the electric power storage device 88 with the generated electric power without suppressing the electric power generation in step S3e, and advances the process to step S3f.

In step S3f, the control device 200 stops the driving of the injector 44 and advances the process to step S3g.

In step S3g, the control device 200 drives the compressor 22 at the minimum lift-off rotational speed Nmin (predetermined rotational speed) at which the rotor shaft portion 274 of the compressor 22 can be lifted off, ends the transition process, and advances the process to step S4.

In step S4 of FIG. 3, the control device 200 determines whether or not it is necessary to return from the idle stop operation to the normal operation.

For example, in the case that the accelerator depression amount sensor 204 detects depression of the accelerator pedal, the control device 200 determines Yes that there is a required output corresponding to the depression amount (step S4: YES), and advances the process to step S5.

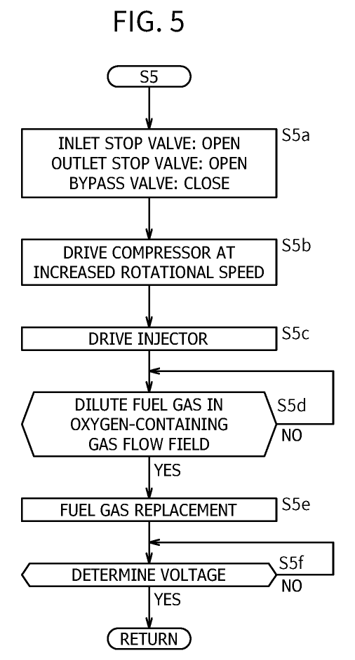

In step S5, the return processing unit 212 of the control device 200 performs return process from the idle stop operation to the normal operation. FIG. 5 shows a subroutine of the return process.

In step S5a, the control device 200 opens the inlet stop valve 118 and the outlet stop valve 120, closes the bypass valve 122, and advances the process to step S5b.

In step S5b, the control device 200 drives the compressor 22 at the maximum rotational acceleration (maximum amount of increase in flow rate) until the rotational speed (flow rate) of the compressor 22 reaches the rotational speed corresponding to the required output, and advances the process to step S5c. In this case, the rotational speed of the compressor 22 increases from the minimum lift-off rotational speed Nmin at which the rotor shaft portion 274 is lifted off and rotated, and thus the rotational speed increases smoothly and quickly.

In step S5c, the control device 200 drives the injector 44 so as to achieve an anode pressure corresponding to the required output, and advances the process to step S5d.

The processes of steps S5b and S5c are started at the same time, and the oxygen-containing gas is supplied from the compressor 22 to the fuel cell 14 through the oxygen-containing gas supply flow path 62, and the fuel gas is supplied from the hydrogen tank 42 to the fuel cell 14 through the fuel gas supply flow path 72.

In step S5d, the control device 200 determines whether the dilution process of the fuel gas that has permeated from the anode flow field 59 to the cathode flow field 58 via the electrolyte membrane 55 has been completed during the idle stop operation.

The dilution process of the fuel gas is terminated when the dilution oxygen-containing gas is supplied from the compressor 22 to the cathode flow field 58 of the fuel cell 14 to the cumulative amount (the dilution oxygen-containing gas cumulative amount) corresponding to the hydrogen permeation cumulative amount in the period of the idle stop operation time, which is obtained in advance (step S5d: YES). Then, the process is advanced to step S5e.

The dilution oxygen-containing gas cumulative amount can be calculated by the control device 200 by acquiring the flow rate detected by the air flow sensor 116.

In step S5e, the control device 200 performs a fuel gas replacement process in which the purge valve 168 is opened in order to discharge the nitrogen that has permeated from the cathode flow field 58 to the anode flow field 59 through the electrolyte membrane 55 during the idle stop operation, and advances the process to step S5f.

The purge valve 168 is closed when, for example, the concentration value measured by a hydrogen concentration meter (not shown) provided in the fuel off-gas discharge flow path 74 reaches a predetermined value (a value for determining the end of the fuel gas replacement process).

By the process of step S5e, the gas (anode gas) such as nitrogen remaining on the anode side is discharged to the outside through the purge flow path 67, the purge valve 168, and the discharge flow path 69 via the exhaust gas exhaust port 78.

During the anode gas replacement process, the bypass valve 122 may be slightly opened to dilute the residual gas with the oxygen-containing gas and discharge the diluted residual gas.

In step S5f, the control device 200 sets the generated voltage Vfc to a voltage corresponding to the required output by means of the voltage control unit 82, and when the generated current Ifc corresponding to the required output can be obtained, the control device 200 ends the voltage determination process (step S5f: YES) and returns to the normal operation in step S1.

As described above, according to the embodiment, when the operation is returned from the idle stop operation to the normal operation, the fuel gas and the oxygen-containing gas are simultaneously supplied to the fuel cell 14 to start the electric power generation. According to such a process, the time required for the output of the fuel cell 14 to reach the required output can be shortened. That is, the time of return from the idle stop operation to the normal operation can be shortened.

### Description of Operation of Embodiment with Timing Chart

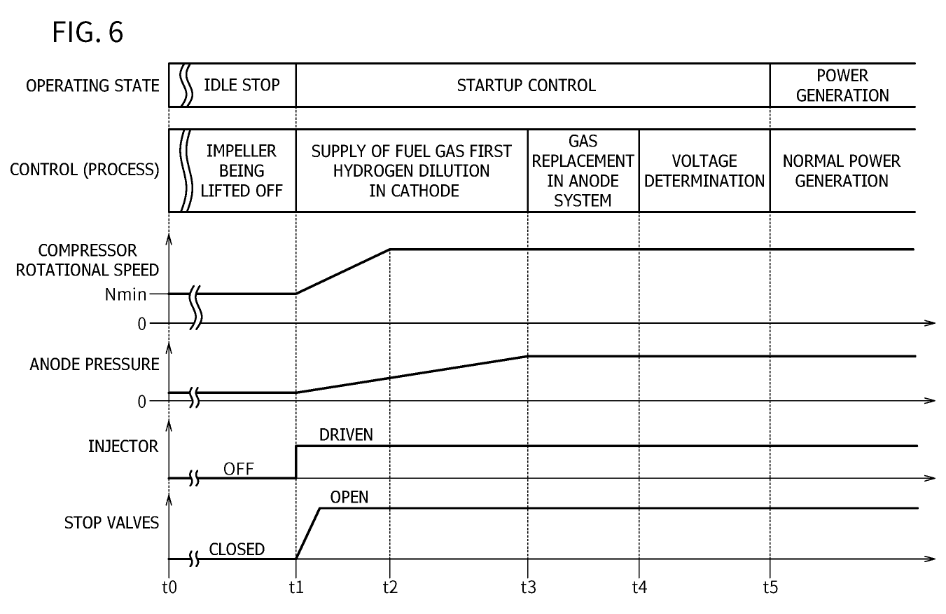

An example of the operation that was described with reference to the flowchart of FIG. 3 will be described with reference to the timing chart of FIG. 6.

The vertical axis of FIG. 6 indicates, in order from the top, the operating state, the control (process), the rotational speed of the compressor 22 (compressor rotational speed) N [rpm], the anode pressure Pa [Pa], the state of the injector 44 (OFF or Driven), and the open or closed state of the inlet stop valve 118 and the outlet stop valve 120.

The period from time t0 to time t1 is the period of the idle stop operation time, and during this period, the control device 200 operates the impeller 276 of the compressor 22 at the minimum lift-off rotational speed Nmin. In this case, since the inlet stop valve 118 and the outlet stop valve 120 are closed, a small amount of the oxygen-containing gas flowing out of the compressor 22 is discharged to the outside through the bypass flow path 66, the discharge flow paths 64, 69, and the exhaust gas exhaust port 78 by opening the bypass valve 122.

Further, since the injector 44 is in the OFF state (non-driven state) and the drain valve 164 and the purge valve 168 are closed, a predetermined anode pressure by the fuel gas is applied to the electrolyte membrane 55.

When the return from the idle stop operation to the normal operation is detected at time t1 (step S4: YES), the injector 44 is driven. As a result, the anode pressure increases at a predetermined rate after time t1.

On the other hand, at time t1, the inlet stop valve 118 and the outlet stop valve 120 are opened and the bypass valve 122 is closed, simultaneously with the supply of the fuel gas (supply of the fuel gas first).

Further, at time t1, the compressor 22 is driven at the maximum amount of increase in flow rate (the maximum rotational acceleration). At time t2, the compressor rotational speed N of the compressor 22 reaches the rotational speed corresponding to the required output in a short time.

Before time t3, the hydrogen dilution process in the cathode flow field 58 (hydrogen dilution in cathode) is terminated when the dilution oxygen-containing gas cumulative amount in the cathode flow field 58 reaches a predetermined value.

At time t3, the anode pressure rises to a pressure corresponding to the required output.

Thereafter, after the gas replacement process in the anode system including the anode flow field 59 from time t3 to time t4, the voltage determination process of the power generation voltage Vfc of the fuel cell 14 from time t4 to time t5 is ended. A series of startup control is completed in a period from time t1 to time t5, and the operation is returned to the normal power generation operation after time t5.

In the above-described embodiment, attention is paid to the fact that the duration of the idle stop operation is shorter than the stoppage time, and it is considered that the amount of the fuel gas permeating the electrolyte membrane 55 (the permeation fuel gas amount) from the anode flow field 59 during the duration is small. Thus, the dilution oxygen-containing gas cumulative amount used for the completion determination of return to an idling state (between time t1 and time t3 in FIG. 6) can be set to a smaller value than that at the time of return from stoppage. Therefore, the required time period for return to the idling state can be shortened.

Further, when the operation is returned from the idle stop operation to the normal operation, since a sufficient amount of the fuel gas remains in the anode system including the anode flow field 59, even if the supply of the fuel gas and the supply of the oxygen-containing gas are started at the same time, the deterioration of the fuel cell 14 can be prevented.

### Supplementary Notes

With respect to the above disclosure, the following supplementary notes are disclosed.

### Supplementary Note 1

The fuel cell system (10) includes the fuel cell (14) configured to generate electric power by using the fuel gas and the oxygen-containing gas, the fuel gas supply device (40) configured to supply the fuel gas to the fuel cell through the fuel gas supply flow path (72), the oxygen-containing gas supply device (20) configured to supply the oxygen-containing gas to the fuel cell through the oxygen-containing gas supply flow path (62), and the control device (200) configured to control the fuel cell, the fuel gas supply device, and the oxygen-containing gas supply device, wherein the control device includes the idle stop determination unit (210) configured to determine the transition from the normal operation in which the fuel cell generates the electric power to the idle stop operation in which the fuel cell temporarily stops electric power generation and to determine the return from the idle stop operation to the normal operation, and the return processing unit (212) configured to, in the case that the return to the normal operation is determined by the idle stop determination unit, start supplying the fuel gas from the fuel gas supply device to the fuel cell and supply the oxygen-containing gas from the oxygen-containing gas supply device to the fuel cell. In accordance with such a configuration, when the operation is returned from the idle stop operation to the normal operation, the fuel gas and the oxygen-containing gas are simultaneously supplied to the fuel cell to start electric power generation. Thus, the time (from time t1 to time t5) until the output of the fuel cell reaches the required output at the time of return from the idle stop operation is shortened, and as a result, the time of return (from time t1 to time t5) from the idle stop operation to the normal operation can be shortened as compared with the time of return after the stoppage.

### Supplementary Note 2

The fuel cell system according to Supplementary Note 1 may further include the inlet stop valve (118) configured to block the oxygen-containing gas supply flow path, the oxygen-containing off-gas discharge flow path (63) through which the oxygen-containing off-gas used for the electric power generation is discharged from the fuel cell, the outlet stop valve (120) configured to adjust the flow rate of the oxygen-containing off-gas discharge flow path, the bypass flow path (66) connecting the oxygen-containing gas supply flow path and the oxygen-containing off-gas discharge flow path, and the bypass valve (122) configured to block the bypass flow path, wherein the control device may be configured to, in the case that the transition to the idle stop operation is determined by the idle stop determination unit, set each of the inlet stop valve and the outlet stop valve to the valve closed state, set the bypass valve to the valve open state, cause the oxygen-containing gas to flow out from the outlet of the oxygen-containing gas supply device at the predetermined flow rate, and discharge the oxygen-containing gas that has flowed out at the predetermined flow rate to outside through the bypass flow path. In accordance with such a configuration, during the idle stop operation time, the oxygen-containing gas is caused to flow out from the outlet of the oxygen-containing gas supply device to the outside at the predetermined flow rate. Thus, when the operation is returned to the normal operation, the oxygen-containing gas corresponding to the required output can be supplied from the oxygen-containing gas supply device to the fuel cell without delay.

### Supplementary Note 3

The fuel cell system according to Supplementary Note 2 may further include the flow rate sensor (116) provided in the oxygen-containing gas supply flow path, wherein the control device may be configured to, in the case that the return from the idle stop operation to the normal operation is determined by the idle stop determination unit, set each of the inlet stop valve and the outlet stop valve to the valve open state, and when the cumulative amount of the oxygen-containing gas flowing out from the outlet of the oxygen-containing gas supply device reaches the predetermined cumulative value, determine that the fuel gas remaining in the oxygen-containing gas flow field of the fuel cell during the time of the idle stop operation is discharged. In this way, when the operation is returned from the idle stop operation to the normal operation and when the cumulative amount of the oxygen-containing gas flowing out from the outlet of the oxygen-containing gas flow field reaches the predetermined cumulative value, it is determined that the fuel gas remaining in the oxygen-containing gas flow path of the fuel cell is discharged. Thus, it is possible to manage the time of return to the normal operation while suppressing the deterioration of the fuel cell.

### Supplementary Note 4

In the fuel cell system according to Supplementary Note 2, when the operation is returned from the idle stop operation to the normal operation, the flow rate of the oxygen-containing gas flowing out from the outlet of the oxygen-containing gas supply device may be increased at the predetermined flow rate, to the flow rate corresponding to the required output at the maximum amount of increase in flow rate of the oxygen-containing gas supply device. In this way, when the operation is returned from the idle stop operation to the normal operation, the flow rate of the oxygen-containing gas is increased to the flow rate corresponding to the required output at the maximum amount of increase in flow rate of the oxygen-containing gas supply device. Thus, it is possible to discharge the residual fuel gas into the oxygen-containing gas flow field of the fuel cell in a short time.

### Supplementary Note 5

In the fuel cell system according to Supplementary Note 2, the oxidant gas supply device may include the compressor (22) configured to cause the impeller (276) to lift off by using the air bearing (292), and the impeller is in the lift-off state when the oxygen-containing gas is caused to flow out from the compressor at the predetermined flow rate during the time of the idle stop operation, the fuel gas supply device includes the fuel tank (42) and the injector (44) connected to the fuel tank, and wherein the control device may be configured to, when the operation is returned from the idle stop operation to the normal operation, simultaneously supply the oxygen-containing gas and the fuel gas to the fuel cell, the oxygen-containing gas being supplied to the fuel cell by increasing a rotational speed of the impeller, opening the inlet stop valve and the outlet stop valve, and closing the bypass valve, and the fuel gas being supplied to the fuel cell by driving the injector. In accordance with such a configuration, the rotational speed of the compressor can be smoothly and quickly increased when the operation is returned from the idle stop operation to the normal operation.

### Supplementary Note 6

The fuel cell system according to any one of Supplementary Notes 2 to 5 may further include the electric power storage device (88) configured to be charged with the electric power generated by the fuel cell and to discharge the electric power generated by the fuel cell, the state-of-charge sensor (94) configured to detect the state-of-charge of the electric power storage device, the current sensor (112) configured to detect the value of the generated current that is generated by the fuel cell, wherein the control device may be configured to, when the transition from the normal operation to the idle stop operation is determined by the idle stop determination unit, perform electric power generation control on the fuel cell to suppress the value of generated current in the manner so that the state-of-charge detected by the state-of-charge sensor does not exceed the threshold value. In accordance with such a configuration, the oxygen-containing gas in the oxygen-containing gas flow field of the fuel cell is consumed at the time of transition to the idle stop operation. However, when the SOC is equal to or higher than a predetermined value, the generated current value is suppressed. Thus, it is possible to avoid excessive electric power generation of the fuel cell during the idle stop operation time.

### Supplementary Note 7

According to the method of returning from the idle stop operation to the normal operation in the fuel cell system, the fuel cell system includes the fuel cell configured to generate electric power by using the fuel gas and the oxygen-containing gas, the fuel gas supply device configured to supply the fuel gas to the fuel cell through the fuel gas supply flow path, the oxygen-containing gas supply device configured to supply the oxygen-containing gas to the fuel cell through the oxygen-containing gas supply flow path, and the control device configured to control the fuel cell, the fuel gas supply device, and the oxygen-containing gas supply device, wherein the method includes the idle stop operation determination step (steps S2 and S3) of determining the transition from the normal operation in which electric power generation of the fuel cell is performed to the idle stop operation in which the electric power generation of the fuel cell is temporarily stopped, and determining the return from the idle stop operation to the normal operation, and the return process step (step S5), in the case that the return to the normal operation is determined in the idle stop determination step, starting supplying the fuel gas from the fuel gas supply device to the fuel cell and supplying the oxygen-containing gas from the oxygen-containing gas supply device to the fuel cell. In accordance with such steps, when the operation is returned from the idle stop operation to the normal operation, the fuel gas and the oxygen-containing gas are simultaneously supplied to the fuel cell to start electric power generation. Thus, the time until the output of the fuel cell reaches the required output at the time of return from the idle stop operation is shortened, and as a result, the time of return from the idle stop operation to the normal operation can be shortened as compared with the time of return after the stoppage.

The present disclosure is not necessarily limited to the specific embodiments described above. These embodiments may be subjected to various additions, substitutions, modifications, partial deletions and the like, within a range that does not deviate from the essence and gist of the present disclosure, or the spirit of the present disclosure as derived from the content described in the claims and equivalents thereof. These embodiments may also be implemented in combination. For example, in the embodiments described above, the order of the operations and the order of the processes are shown as examples, and the present invention is not limited to such operations and processes. The same applies to the case where numerical values or mathematical expressions are used in the description of the above-described embodiments.

1. A fuel cell system comprising:
a fuel cell configured to generate electric power by using a fuel gas and an oxygen-containing gas;
a fuel gas supply device configured to supply the fuel gas to the fuel cell through a fuel gas supply flow path;
an oxygen-containing gas supply device configured to supply the oxygen-containing gas to the fuel cell through an oxygen-containing gas supply flow path; and
one or more processors that execute computer-executable instructions stored in a memory,
wherein the one or more processors execute the computer-executable instructions to cause the fuel cell system to:
determine a transition from a normal operation in which the fuel cell generates the electric power to an idle stop operation in which the fuel cell temporarily stops electric power generation, and determine a return from the idle stop operation to the normal operation;
in a case that the return from the idle stop operation to the normal operation is determined, start supplying the fuel gas from the fuel gas supply device to the fuel cell and supply the oxygen-containing gas from the oxygen-containing gas supply device to the fuel cell.

2. The fuel cell system according to claim 1, further comprising:
an inlet stop valve configured to block the oxygen-containing gas supply flow path;
an oxygen-containing off-gas discharge flow path through which an oxygen-containing off-gas used for the electric power generation is discharged from the fuel cell;
an outlet stop valve configured to adjust a flow rate of the oxygen-containing off-gas discharge flow path;
a bypass flow path connecting the oxygen-containing gas supply flow path and the oxygen-containing off-gas discharge flow path; and
a bypass valve configured to block the bypass flow path,
wherein the one or more processors execute the computer-executable instructions to cause the fuel cell system to:
in a case that the transition to the idle stop operation is determined, set each of the inlet stop valve and the outlet stop valve to a valve closed state, set the bypass valve to a valve open state, cause the oxygen-containing gas to flow out from an outlet of the oxygen-containing gas supply device at a predetermined flow rate, and discharge the oxygen-containing gas that has flowed out at the predetermined flow rate to outside through the bypass flow path.

3. The fuel cell system according to claim 2, further comprising a flow rate sensor provided in the oxygen-containing gas supply flow path,
wherein the one or more processors execute the computer-executable instructions to cause the fuel cell system to:
in a case that the return from the idle stop operation to the normal operation is determined, set each of the inlet stop valve and the outlet stop valve to the valve open state, and when a cumulative amount of the oxygen-containing gas flowing out from the outlet of the oxygen-containing gas supply device reaches a predetermined cumulative value, determine that the fuel gas remaining in the oxygen-containing gas flow field of the fuel cell during time of the idle stop operation is discharged.

4. The fuel cell system according to claim 2, wherein the one or more processors execute the computer-executable instructions to cause the fuel cell system to:
when an operation is returned from the idle stop operation to the normal operation, increase the flow rate of the oxygen-containing gas flowing out from the outlet of the oxygen-containing gas supply device at the predetermined flow rate, to a flow rate corresponding to a required output at a maximum amount of increase in flow rate of the oxygen-containing gas supply device.

5. The fuel cell system according to claim 2, wherein the oxygen-containing gas supply device includes a compressor configured to cause an impeller to lift off by using an air bearing, and the impeller is in a lift-off state when the oxygen-containing gas is caused to flow out from the compressor at the predetermined flow rate during time of the idle stop operation,
the fuel gas supply device includes a fuel tank and an injector connected to the fuel tank, and
wherein the one or more processors execute the computer-executable instructions to cause the fuel cell system to:
when an operation is returned from the idle stop operation to the normal operation, simultaneously supply the oxygen-containing gas and the fuel gas to the fuel cell, the oxygen-containing gas being supplied to the fuel cell by increasing a rotational speed of the impeller, opening the inlet stop valve and the outlet stop valve, and closing the bypass valve, and the fuel gas being supplied to the fuel cell by driving the injector.

6. The fuel cell system according to claim 2, further comprising:
an electric power storage device configured to be charged with the electric power generated by the fuel cell and to discharge the electric power generated by the fuel cell;
a state-of-charge sensor configured to detect a state-of-charge of the electric power storage device;
a current sensor configured to detect a value of a generated current that is generated by the fuel cell,
wherein the one or more processors execute the computer-executable instructions to cause the fuel cell system to:
when the transition from the normal operation to the idle stop operation is determined, perform electric power generation control on the fuel cell to suppress the value of generated current in a manner so that the state-of-charge detected by the state-of-charge sensor does not exceed a threshold value.

7. A method of returning from an idle stop operation to a normal operation in a fuel cell system, the method being executed by one or more processors,
wherein the fuel cell system includes a fuel cell configured to generate electric power by using a fuel gas and an oxygen-containing gas, a fuel gas supply device configured to supply the fuel gas to the fuel cell through a fuel gas supply flow path, and an oxygen-containing gas supply device configured to supply the oxygen-containing gas to the fuel cell through an oxygen-containing gas supply flow path, the method comprising:
causing the one or more processors to perform an idle stop determination for determining a transition from the normal operation in which electric power generation of the fuel cell is performed to the idle stop operation in which the electric power generation of the fuel cell is temporarily stopped, and determine a return from the idle stop operation to the normal operation; and
causing the one or more processors to, in a case that the return to the normal operation is determined in the idle stop determination, perform a return process for starting supplying the fuel gas from the fuel gas supply device to the fuel cell and supplying the oxygen-containing gas from the oxygen-containing gas supply device to the fuel cell.
